(19) United States
(12) Patent Application Publication
(10) Pub. No.: US 2011/0240451 A1
(43) Pub. Date: Oct. 6, 2011

(54) KEY INPUT UNIT

(75) Inventors: Young-Joo PARK, Yongin-si (KR); Sun-Gi HONG, Seoul (KR); Hae-Don CHON, Yongin-si (KR)

(73) Assignee: Samsung Electronics Co., Ltd., Gyeonggi-do (KR)

(21) Appl. No.: 13/075,915

(22) Filed: Mar. 30, 2011

(30) Foreign Application Priority Data
Mar. 31, 2010 (KR) 10-2010-0029538

(51) Int. Cl. H01H 13/76

(52) U.S. Cl. 200/5 A

(57) ABSTRACT

Provided is a key input unit for facilitating a user's input operation, including a plurality of keys and a space key provided between two predetermined key columns among the plurality of keys. The key input unit also includes a plurality of keys and a predetermined region surrounding the plurality of keys, in which the predetermined region is used as a space function.

### PRIORITY

This application claims priority under 35 U.S.C. §119(a) to an application filed in the Korean Intellectual Property Office on Mar. 31, 2010, and assigned Serial No. 10-2010-0029538, the entire disclosure of which is incorporated herein by reference.

### BACKGROUND OF THE INVENTION

1. Field of the Invention

The present invention generally relates to a key input unit and, more particularly, to a key input unit for facilitating a user's input operation.

2. Description of the Related Art

A QWERTY key input unit including physical or virtual keys has been applied to most smart phones. FIG. 1 illustrates a general QWERTY key input unit.

As illustrated in FIG. 1, the QWERTY key input unit is generally formed in a very compact fashion and a user can input a plurality of characters through the familiar QWERTY key input unit.

The user usually operates the compact QWERTY key input unit using two thumbs, which may inconvenience the user who is accustomed to using ten fingers for a general full-size key input unit of the type provided in a Personal Computer (PC).

For example, the two thumbs may often overlap when inputting “t” and “h”, “g” and “h”, or “n” and “g”, resulting in erroneous input. Moreover, in the QWERTY key input unit, a space key is often provided in an unfamiliar position or formed with a small width, whereby the space key cannot be easily accessed by the user's two thumbs.

### SUMMARY OF THE INVENTION

Accordingly, the present invention overcomes the above-mentioned problems with conventional devices and an aspect of the present invention is to provide a key input unit for facilitating input of a space key.

Another aspect of the present invention is to provide a key input unit for preventing erroneous input of frequently used keys.

According to an aspect of the present invention, there is provided a key input unit including a plurality of keys and a space key provided between two predetermined key columns among the plurality of keys.

According to another aspect of the present invention, there is provided a key input unit including a plurality of keys and a predetermined region surrounding the plurality of keys, in which the predetermined region is used as a space function.

### BRIEF DESCRIPTION OF THE DRAWINGS

The above and other features and advantages of exemplary embodiments of the present invention will be more apparent from the following detailed description taken in conjunction with the accompanying drawings, in which:

FIG. 1 illustrates a key input unit including a general QWERTY key arrangement;

FIG. 2 is a block diagram of a portable terminal according to an embodiment of the present invention;

FIG. 3 illustrates a key input unit according to an embodiment of the present invention; and

FIG. 4 illustrates a key input unit according to another embodiment of the present invention.

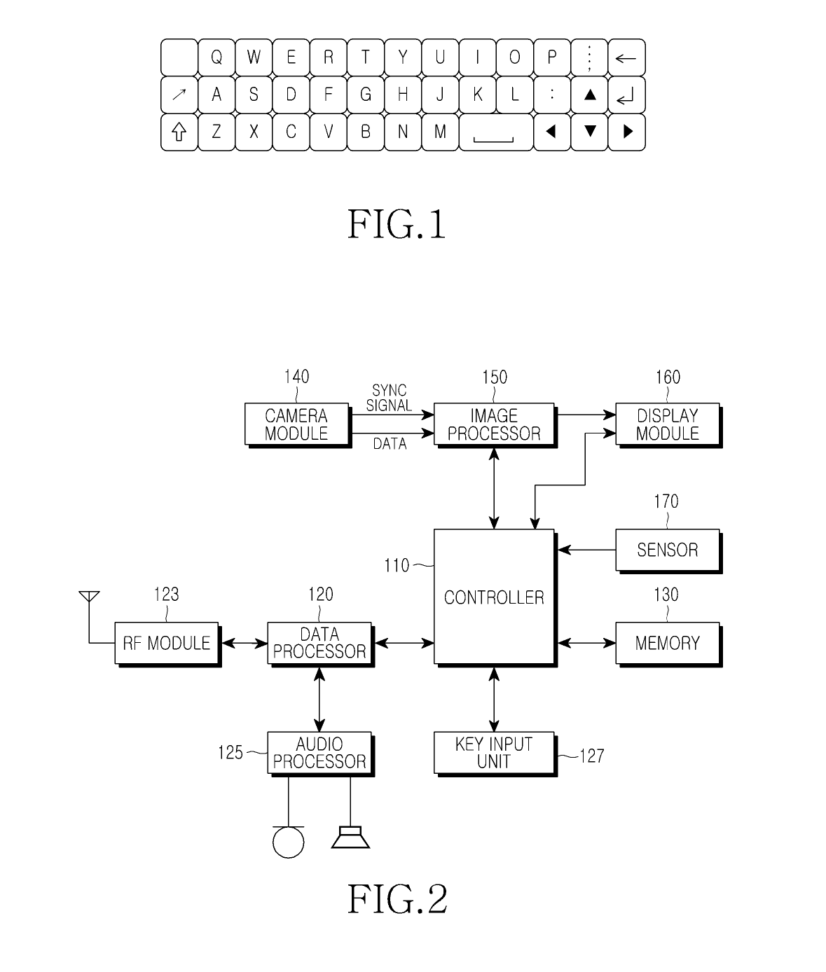

### DETAILED DESCRIPTION OF EMBODIMENTS OF THE PRESENT INVENTION

Hereinafter, embodiments of the present invention will be described in detail with reference to the accompanying drawings. It should be noted that similar components are referred to with the same reference numerals in the drawings.

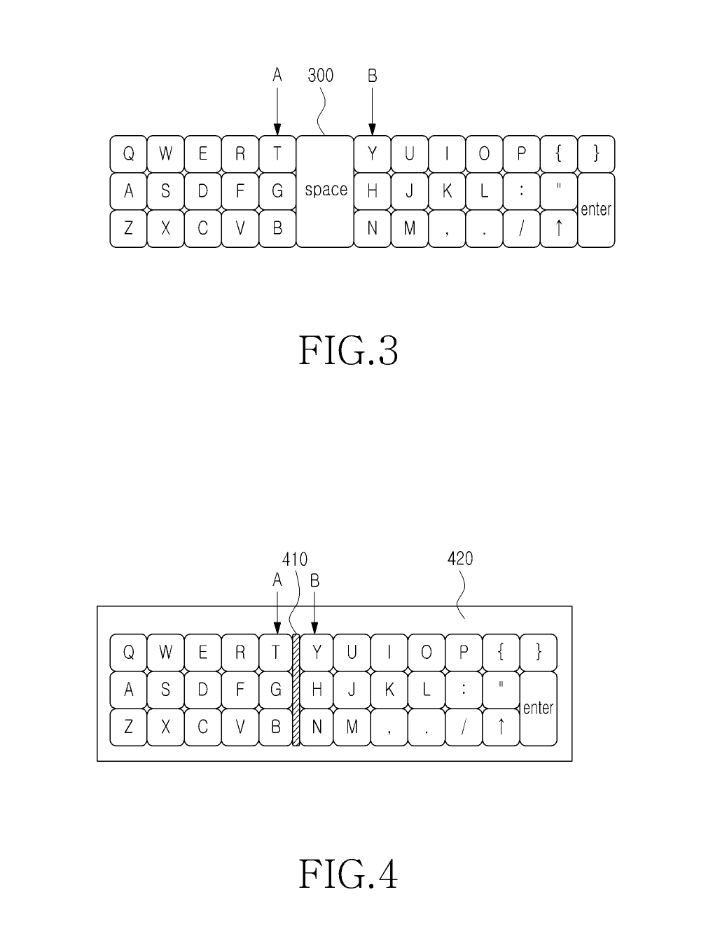

FIG. 2 is a block diagram of a portable terminal according to an embodiment of the present invention, FIG. 3 illustrates a key input unit according to an embodiment of the present invention, and FIG. 4 illustrates a key input unit according to another embodiment of the present invention.

Referring to FIG. 2, a Radio Frequency (RF) module 123 performs radio communication of the portable terminal. The RF module 123 includes an RF transmitter for up-converting a frequency of a transmission signal and amplifying the transmitted signal and an RF receiver for low-noise amplifying a received signal and down-converting the frequency of the received signal. A data processor 120 includes a transmitter for encoding and modulating the transmission signal and a receiver for demodulating and decoding the received signal. In other words, the data processor 120 may include a modem and a codec. Herein, the codec includes a data codec for processing packet data and an audio codec for processing an audio signal such as voice. An audio processor 125 reproduces an audio signal being output from the audio codec of the data processor 120 or transmits an audio signal generated from a microphone to the audio codec of the data processor 120.

A memory 130 includes program and data memories. The program memory stores programs for controlling a general operation of the portable terminal. The data memory temporarily stores data generated during execution of the programs.

A camera module 140 captures an image, and may include a camera sensor for converting an optical signal of the captured image into an electrical signal, and a signal processor for converting an analog image signal of the image captured by the camera sensor into digital data. The camera sensor is preferably a Charge Coupled Device (CCD) sensor or a Complementary Metal Oxide Semiconductor (CMOS) sensor, and the signal processor may be implemented as a Digital Signal Processor (DSP). In addition, the camera sensor and the signal processor may be implemented as one piece or separately.

An image processor 150 performs Image Signal Processing (ISP) to display an image signal output from the camera module 140 on a display module 160. The ISP executes functions such as gamma correction, interpolation, color space conversion, image effect, image scale, Auto White Balance (AWB), Auto Exposure (AE) and Auto Focus (AF). Thus, the image processor 150 processes the image signal output from the camera module 140 in the unit of a frame, and outputs frame image data adaptively to the features and size of the display module 160. The image processor 150 includes an image codec, and compresses the frame image data displayed on the display section 160 in a preset manner or restores the compressed frame image data to the original frame image data. Herein, the image codec may be Joint Picture Experts Group (JPEG) codec, Moving Picture Experts Group 4 (MPEG4) codec, or Wavelet codec. It is assumed that the image processor 150 has an On Screen Display (OSD) function. The image processor 150 may output OSD data according to the displayed picture size under the control of a controller 110.

The controller 110 controls overall operation of the portable terminal. The controller 110 controls an input operation through the key input unit 127 including a plurality of keys and a space key provided between two predetermined key columns from among the plurality of keys according to an embodiment of the present invention.

The controller 110 also controls an input operation via the key input unit 127 including a plurality of keys and a predetermined region surrounding the plurality of keys, which is recognized as a space key by a touch operation, according to another embodiment of the present invention.

Once the portable terminal is touched to perform a space function in an input mode, a sensor 170 senses the touch signal and transmits the sensed signal to the controller 110. The touch on the portable terminal for the space function in the input mode may be made by a single touch or two consecutive touches for a predetermined time or a continuous touch for a predetermined time. The sensor 170 is intended to sense the touch for performing the space function in the input mode, regardless of a position of the touch on the portable terminal. The sensor 170 may be, for example, a gyro sensor, a touch sensor, a pressure sensor, or a touch sensor.

The display module 160 displays an image signal output from the image processor 150 on the screen and displays user data output from the controller 110.

The display module 160 may be a Liquid Crystal Display (LCD), and in this case, the display module 160 may include an LCD controller, a memory capable of storing image data, an LCD element, and so on. The display module 160 may also include a touch screen module to serve as an input unit.

The key input unit 127 includes keys for inputting numeric and character information and function keys for setting various functions.

In an embodiment of the present invention, the key input unit 127 includes a plurality of keys and a space key provided between two predetermined key columns from among the plurality of keys.

The space key in a longitudinally elongated shape is positioned at a center of the key input unit 127, such that the user can easily access the space key with either of two thumbs which are most frequently used to input characters and/or numbers in the input mode.

Character keys and/or number keys included in the two key columns at both sides of the space key are used more than a predetermined number of times in the input mode, that is, they may be character keys and/or number keys which are most frequently used among the plurality of keys.

Accordingly, the space key serves as a separator between the two key columns including the most frequently used character keys and/or number keys, thereby reducing the probability of erroneous input caused by overlap between two thumbs used for key input in the input mode.

The key input unit 127 may include physical keys or may be displayed as an input unit on the display unit 160 implemented with a touch screen module.

For the configuration of the key input unit 127, FIG. 3 illustrates the key input unit 127 composed of a QWERTY key arrangement according to an embodiment of the present invention.

Referring to FIG. 3, a space key 300 has an elongated shape arranged in a transverse direction relative to key input unit 127. The space key 300 is also positioned at the center of the key input unit 127. Thus, in the input mode, the user can easily input the elongated space key 300, positioned at the center while inputting characters and/or numbers with both two thumbs.

Such configuration conforms the aim of faithfully following a general principle that a space key of a general full-size key input unit is defined with a position and a size which guarantees the same accessibility by either thumb.

Since “ty”, “gh”, “th”, and “ng” are frequently used characters in an English input mode, the space key 300 is positioned between a first key column (‘A’ in FIGS. 3 and 4) in which “T”, “G”, and “B” are vertically disposed and a second key column (‘B’) in which “Y”, “H”, and “N” are vertically disposed. Thus, with space key 300 serving as a separator between the first and second key columns A and B, erroneous input caused by overlap between two thumbs used for key input during input of “ty”, “gh”, “th”, or “ng” in the input mode can be reduced and psychological stability can also be provided to the user with the reduction of erroneous input.

When the key input unit 127 shown in FIG. 3 is displayed on the display unit 160 implemented with the touch screen module, the position of the space key 300 may be changed by user's selection, or may be flexibly disposed and displayed between two key columns including character keys and/or number keys, which have been most frequently used, that is, have been used more than a predetermined number of times for a predetermined time in the input mode.

In another embodiment of the present invention, the key input unit 127 includes a plurality of keys and a predetermined region 420 surrounding the plurality of keys, and a touch on the surrounding predetermined region 420 is recognized as a space key input.

As the touch on the predetermined region surrounding the plurality of keys in the key input unit 127 serves as the space function, the user can conveniently use the space function when inputting characters and/or numbers with two thumbs in the input mode.

Meanwhile, a predetermined space is preferably provided between two predetermined key columns by reducing the size of keys included in the two key columns among the plurality of keys. Character keys and/or number keys included in the two key columns may have been used more than a predetermined number of times in the input mode, that is, have been most frequently used among the plurality of keys.

Thus, the predetermined space provided between the two key columns including the most frequently used character keys and/or number keys serves as a separator, thereby reducing erroneous input caused by overlap between two thumbs used for key input in the input mode.

The key input unit 127 may also be displayed as an input unit on the display unit 160 implemented with the touch screen module.

Regardless of whether the predetermined region (420 of FIG. 4) exists in the key input unit 127, once the portable terminal including the key input unit 127 is touched during input of a character and/or number through the key input unit 127 in the input mode, the sensor 170 senses the touch signal and transmits the sensed signal to the controller 110. The controller 110 then recognizes the sensed touch signal as the space key input and performs the space function.

For the configuration of the key input unit 127, FIG. 4 illustrates the key input unit 127 composed of a QWERTY key arrangement according to another embodiment of the present invention.

Referring to FIG. 4, the key input unit 127 includes a plurality of keys and the predetermined region 420 surrounding the plurality of keys, to execute the space function by touch input. Thus, by touching the predetermined region 420 during input of a character and/or number with two thumbs in the input mode, the user can easily execute the space function because the touch is recognized as a space key input.

Such a configuration makes the space input easy by allowing a touch anywhere in the predetermined region 420 surrounding the plurality of keys, and provides user flexibility of a touch key input unit controlled by software.

Since “ty”, “gh”, “th”, and “ng” are frequently used characters in the English input mode, a predetermined space 410 is provided between the first key column ‘A’ in which “T”, “G”, and “B” are disposed and the second key column ‘B’ in which “Y”, “H”, and “N” are disposed, by reducing the width (i.e. horizontal size) of the T, G, and B keys and of the Y, H, and N keys.

Thus, with the predetermined space 410 serving as a separator between the first and second two key columns A and B, erroneous input caused by overlap between two thumbs used for key input during input of “ty”, “gh”, “th”, or “ng” in the input mode can be reduced and psychological stability can also be provided to the user with the reduction of erroneous input.

As apparent from the foregoing description, by providing the key input unit, the space key input can be facilitated when using the key input unit with two thumbs, and erroneous input can be reduced by preventing overlap between two thumbs for inputting frequently used keys, thereby allowing convenient key input.

While the present invention has been shown and described with reference to exemplary embodiments thereof, it will be understood by those skilled in the art that various changes in form and details may be made therein without departing from the spirit and scope of the invention as defined by the appended claims. Therefore, the scope of the present invention should be defined by the appended claims and equivalents thereof, rather than the disclosed embodiment.

What is claimed is:

1. A key input unit comprising:
a plurality of keys; and
a space key provided between two predetermined key columns among the plurality of keys.

2. The key input unit of claim 1, wherein the space key has an elongated shape arranged in a transverse direction and is positioned at a center among the plurality of keys.

3. The key input unit of claim 1, wherein the two predetermined key columns comprise character keys and/or number keys which are used more than a predetermined number of times.

4. The key input unit of claim 1, wherein the two predetermined key columns form a QWERTY key arrangement having a first key column with “T”, “G” and “B” keys disposed on one side and a second key column with “Y”, “H” and “N” keys disposed on an other side of the space key.

5. The key input unit of claim 1, wherein the key input unit is arranged using physical keys.

6. The key input unit of claim 1, wherein the key input unit is arranged using a touch screen module.

7. A key input unit comprising:
a plurality of keys; and
a predetermined region surrounding the plurality of keys,
wherein the predetermined region is used as a space function.

8. The key input unit of claim 7, wherein a predetermined space is provided between two predetermined key columns among the plurality of keys.

9. The key input unit of claim 8, wherein the predetermined space is provided by reducing a size of the plurality of keys included in the two predetermined key columns.

10. The key input unit of claim 8, wherein the two predetermined key columns comprise character keys and/or number keys which are used more than a predetermined number of times.

11. The key input unit of claim 8, wherein the two predetermined two key columns form a QWERTY key arrangement having a first key column with “T”, “G” and “B” keys disposed on one side and a second key column with “Y”, “H” and “N” keys disposed on an other side of the predetermined space.

12. The key input unit of claim 7, wherein the key input unit arranged using a touch screen.

13. The key input unit of claim 7, wherein a space function is executed by touching a device that includes the key input unit.

14. The key input unit of claim 13, further comprising a sensor for executing the space function when the device is touched.
